(19) United States
(12) Patent Application Publication
(10) Pub. No.: US 2017/0086137 A1
(43) Pub. Date: Mar. 23, 2017

(54) ENHANCED UPLINK POWER AND DATA ALLOCATION FOR DUAL BAND DUAL CARRIER HIGH SPEED UPLINK PACKET ACCESS

(71) Applicant: QUALCOMM Incorporated, San Diego, CA (US)

(72) Inventors: Haitong SUN, San Diego, CA (US); Sharad SAMBHWANI, San Diego, CA (US); Ravi AGARWAL, San Diego, CA (US); Francesco PICA, San Diego, CA (US); Sitaramanjaneyulu KANAMARLAPUDI, San Diego, CA (US)

(21) Appl. No.: 15/235,968

(22) Filed: Aug. 12, 2016

Related U.S. Application Data
(60) Provisional application No. 62/220,820, filed on Sep. 18, 2015.

(51) Int. Cl. H04W 52/02; H04W 72/14; H04W 52/14

(52) U.S. Cl. CPC H04W 52/0212; H04W 52/146; H04W 72/14; H04W 88/02

(57) ABSTRACT

Aspects of the present disclosure generally relate to allocating power and/or data to uplink channels for wireless communications. The present aspects include determining an initial transmit power for each of a first carrier and a second carrier for a user equipment (UE). The present aspects further include determining that the initial transmit power of the first carrier is less than the initial transmit power of the second carrier. Additionally, the present aspects include allocating a first transmit power to the first carrier prior to allocating a second transmit power to the second carrier based on determining that the initial transmit power of the first carrier is less than the initial transmit power of the second carrier, the first transmit power is greater than the second transmit power.

### CLAIM OF PRIORITY

The present Application for Patent claims priority to U.S. Provisional Application No. 62/220,820 entitled “ENHANCED UL POWER AND DATA ALLOCATION FOR DUAL BAND DUAL CARRIER HSUPA” filed Sep. 18, 2015, which is assigned to the assignee hereof and hereby expressly incorporated by reference in its entirety herein.

### BACKGROUND

Aspects of the present disclosure relate generally to wireless communication systems, and more particularly, to power and data allocation in a dual band, dual carrier high speed uplink packet access (DB-DC-HSUPA) wireless communication system.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

For example, for dual-band, dual-carrier high-speed uplink packet access (DB-DC-HSUPA), there may exist a power imbalance between the two carriers in use between the user equipment (UE) and the network. However, the network may not account for the power imbalance, which leads to inefficient uplink transmissions. Accordingly, improvements to uplink technology may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

Aspects of the present disclosure generally relate to allocating power and/or data to uplink channels/carriers for wireless communications.

In accordance with an aspect, a method includes a base station operating a power control component for determining, by a power control component of the network, an initial transmit power for each of a first carrier and a second carrier for a user equipment (UE). The described aspects further include determining, by the power control component, that the initial transmit power of the first carrier is less than the initial transmit power of the second carrier. The described aspects further include allocating a first transmit power to the first carrier prior to allocating a second transmit power to the second carrier based on determining that the initial transmit power of the first carrier is less than the initial transmit power of the second carrier, the first transmit power is greater than the second transmit power.

In accordance with an aspect, an apparatus for power allocation includes a memory configured to store data and at least one processor communicatively coupled to the memory. The at least one processor is configured to determine an initial transmit power for each of a first carrier and a second carrier for a user equipment (UE). The at least one processor is further configured to determine that the initial transmit power of the first carrier is less than the initial transmit power of the second carrier. Additionally, the at least one processor is configured to allocating a first transmit power to the first carrier prior to allocating a second transmit power to the second carrier based on determining that the initial transmit power of the first carrier is less than the initial transmit power of the second carrier, the first transmit power is greater than the second transmit power.

In accordance with an aspect, a computer-readable medium storing computer executable code for power allocation includes code for determining an initial transmit power for each of a first carrier and a second carrier for a user equipment (UE). The computer-readable medium further includes code for determining that the initial transmit power of the first carrier is less than the initial transmit power of the second carrier. Additionally, the compute-readable medium includes code for allocating a first transmit power to the first carrier prior to allocating a second transmit power to the second carrier based on determining that the initial transmit power of the first carrier is less than the initial transmit power of the second carrier, wherein the first transmit power is greater than the second transmit power.

In accordance with an aspect, an apparatus for power allocation includes means for determining an initial transmit power for each of a first carrier and a second carrier for a user equipment (UE). The apparatus further includes means for determining that the initial transmit power of the first carrier is less than the initial transmit power of the second carrier. Additionally, the apparatus includes means for means for allocating a first transmit power to the first carrier prior to allocating a second transmit power to the second carrier based on determining that the initial transmit power of the first carrier is less than the initial transmit power of the second carrier, the first transmit power is greater than the second transmit power.

In additional aspects, the disclosure provides an apparatus and method of allocating data to uplink channels for wireless communications. The apparatus and method includes a UE receiving a first power allocation for a first carrier and a second power allocation for a second carrier. In an aspect, the first power allocation may be higher than the second power allocation, and a first transmit power of the first carrier may be lower than a second transmit power of the second carrier. The apparatus and method also includes an uplink control component in the UE selecting an enhanced dedicated channel (E-DCH) transport format combination (E-TFC) for each of the first carrier and the second carrier based on the first power allocation. The apparatus and method also includes the uplink control component allocating data to the first carrier before the second carrier. In an aspect, the uplink control component may fill the first carrier before allocating data to the second carrier.

In additional aspects, an apparatus and method of allocating data to uplink channels for wireless communications is provided. The apparatus and method includes a UE receiving a first power allocation for a first carrier and a second power allocation for a second carrier. In an aspect, the first power allocation may be higher than the second power allocation and a transmit power of the first carrier may be lower than a second transmit power of the second carrier. The apparatus and method also includes an uplink control component in the UE allocating a non-scheduled data flow to the first carrier before the second carrier. In an aspect, the uplink control component may fill the first carrier with non-scheduled data flows before allocating data to the second carrier.

These and other aspects of the invention will become more fully understood upon a review of the detailed description, which follows.

### BRIEF DESCRIPTION OF THE DRAWINGS

FIGS. 1A and 1B are block diagrams illustrating an example communications network including a base station in communication with a user equipment configured to perform power and/or data allocation for uplink channels/carriers in accordance with one or more of the presently described aspects.

FIGS. 2A and 2B are flowcharts conceptually illustrating an example method of power allocation at a network entity in accordance with the described aspects.

FIG. 3 is a flowchart conceptually illustrating an example method of allocating data to uplink channels for wireless communications in accordance with the described aspects.

FIG. 4 is a flowchart conceptually illustrating another example method of allocating data to uplink channels for wireless communications in accordance with the described aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The disclosure provides for various methods, apparatuses, and computer-readable media for establishing and allocating resources for dual-band, dual-carrier high-speed uplink packet access (HSUPA) communication.

The present aspects relate to resource allocation for user equipment's (UEs). Specifically, communication between a UE and a network entity may be conducted using a dual band-dual carrier (DB-DC) scheme on an uplink and/or downlink communication channel. For example, in some aspects, the DB-DC scheme may be employed for uplink communication such as, but not limited to, HSUPA. Using such communication scheme on the uplink enables the use of adjacent uplink carriers for an aggregated data pipe of a given frequency. Further, as the power amplification is similar to the single carrier operation, the two uplink carrier may share the total transmit power.

However, in some aspects, uplink transmission by a UE using DB-DC HSUPA may result in a pathloss imbalance between the two carriers. That is, in some aspects, a pathloss of a first carrier may vary compared to a pathloss of a second carrier. In some aspects, pathloss may be the average attenuation of the uplink signal from the UE to a receiving network entity (e.g., cell). As such, the difference in pathloss between the two carriers may be considered a level or degree of carrier imbalance. Such carrier imbalance, which may correspond to a large pathloss difference between two carriers, may result in suboptimal transmission on the uplink by the UE (e.g., transmission on carrier experiencing higher pathloss) and/or inefficient allocation of resources for the uplink transmission by the network (e.g., power allocation to carrier experiencing higher pathloss than adjacent carrier). Accordingly, it would be desirable for the network to allocate resources for the uplink transmission according to DB-DC HSUPA based on the pathloss of the carriers, which may result in enhanced DB-DC HSUPA communication.

In an aspect, for example, a disclosed apparatus and method in a DB-DC-HSUPA system may prioritize power allocation to a stronger carrier (or channel), e.g., a carrier with a lower path loss. For example, for DB-DC HSUPA, two carriers may have significant pathloss difference (corresponding to high carrier imbalance). In some aspects, when the UE is power limited, different power allocation may result in different uplink throughput. Nonetheless, current implementations often allocate more power on the carrier with higher dedicated packet control channel (DPCCH) transmit power (e.g., carrier with higher pathloss) according to the following example formula:

$${P}_{i} = {P}_{remaining , s} \frac{{P}_{DPCCH , target , i} {SG}_{i}}{{\sum }_{k} {P}_{DPCCH , target , k} {SG}_{k}}$$

where Pᵢ is the allocated power, P_{remaining} is the remaining total power that may be allocated at a UE, P_{DCCH,target} is the power for a given carrier, and SG is the serving grant issued by the network for the UE. In such example, as power is allocated to the carrier experiencing higher pathloss, the allocation may cause DB-DC HSUPA to perform worse compared to single carrier HSUPA on the better carrier.

For instance, when a large carrier balance exists, an imbalance sensitive power allocation approach may improve link or channel efficiency. In particular, the approach may allocate as much power as possible to a stronger carrier (e.g., carrier exhibiting lower pathloss) without violating a serving grant. In turn, the remaining transmit power may be provided to the weaker carrier (e.g., carrier exhibiting higher pathloss relative to the stronger carrier). As such, link or channel efficient may be improved when the UE is power limited without violating grant. Accordingly, performance of DB-DC HSUPA may be

Specifically, the present aspects provide a network entity (e.g., base station) which may use a UE power control component to allocate power to multiple uplink channels (e.g., dedicated packet control channels (DPCCHs)). In an aspect, the power control component may use imbalance-sensitive power allocation by first prioritizing the allocation of power to the uplink channel that uses the lower transmission power (e.g., channel, also referred to as carrier, with the lower path loss), and allocating the remaining transmit power to the other uplink channel. In an aspect, the power control component may first determine whether the relative difference in transmission powers is great enough to prioritize the uplink channel that uses the lower transmission power.

In another aspect, the disclosure provides an apparatus and method in a DB-DC-HSUPA system for allocating data to a stronger one of the uplink channels or carriers. For example, some implementations of data allocation may initially allocate data to a secondary carrier irrespective of a comparative strength of the uplink channels or carriers. Such implementation to allocate data to the secondary carrier first may be beneficial if a non-scheduled flow can only be transmitted on the first/primary carrier and there exists at least one scheduled flow that has higher priority than the non-scheduled flow. As such, allocating to the secondary carrier initially may empty out the queues for the scheduled flows as much as possible before the non-scheduled and scheduled transmissions are mixed together.

However, allocating data to the secondary carrier may have limitations. For example, the non-scheduled flow may often have the highest priority. Accordingly, if the network determines that the non-scheduled flow is critical and delay sensitive, the network may configure it with highest priority. Further, for instance, if the network does not configure the non-scheduled flow with the highest priority, one or a few transmit time interval (TTI) delay of scheduling may not affect performance. As such, the present aspects initially allocate data to the channel or carrier exhibiting lower DPCCH power. In a DB-DC communication environment, two channels or carriers may have significant different uplink pathloss. As such, in the event the UE is buffer limited, transmitting data on the better carrier may improve the channel or link efficiency (e.g., reduce UE transmit power).

Specifically, for example, a UE may receive a power allocation from the network for first and second uplink channels. In an aspect, the first power allocation may be higher than the second power allocation. In an aspect, the transmit power of the first uplink channel may be lower than the transmit power of the second uplink channel. In an aspect, the UE can use an uplink control component to select an enhanced dedicated channel (E-DCH) transport format combination (E-TFC) for each of the uplink channels based on the power allocations. In an aspect, the total power allocation may be greater that the available power at the UE. In such instances, the UE may use the uplink control component to allocate data to the first uplink channel before the allocating power to the second uplink channel. In an aspect, the uplink control component may fill the first uplink channel before allocating data to the second uplink channel.

In another aspect, the disclosure provides an apparatus and method in a DB-DC-HSUPA system for allocating a non-scheduled data flow on a lower band carrier (or channel), which may be the secondary carrier, and which may have a relatively lower path loss. In particular, current implementations may transmit the non-scheduled data flow on the primary channel or carrier. However, for DB-DC-HSUPA, there may be a possibility that the lower band carrier is the secondary carrier, which may have significantly better uplink coverage (e.g., pathloss) compared to the high band carrier. Further, non-scheduled data flow may carry important, delay sensitive data, such as signaling radio bearers (SRBs). As such, the present aspects may allocate and transmit the non-scheduled data flow on the lower band carrier to ensure adequate link efficiency for non-scheduled flow and improve robustness of the call.

Specifically, for example, a UE can receive power allocations from the network for first and second uplink channels. In an aspect, the first power allocation may be higher than the second power allocation. In an aspect, the transmit power of the first uplink channel may be lower than the transmit power of the second uplink channel. In an aspect, the UE can use the uplink control component to allocate a non-scheduled data flow to the first uplink before the second uplink channel. In an aspect, the uplink control component may fill the first carrier with non-scheduled data flows before allocating data to the second carrier. In an aspect, the first uplink channel may have a lower operating frequency than the second uplink channel.

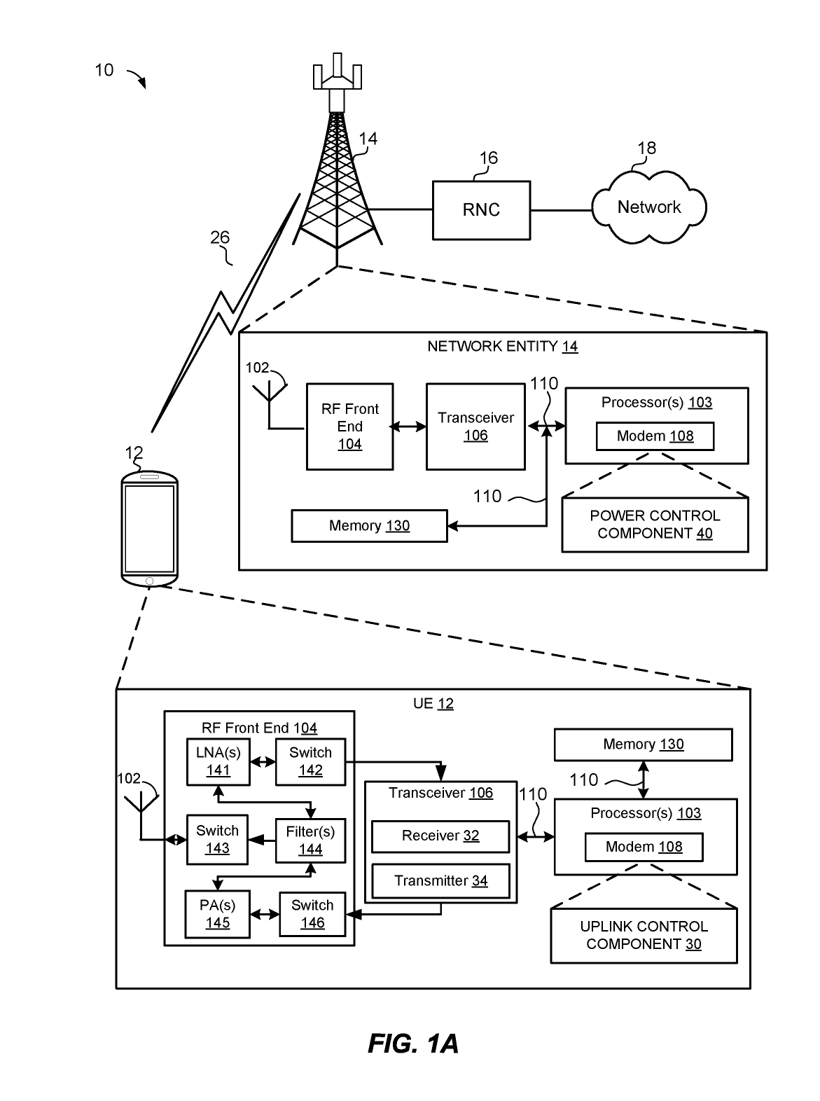

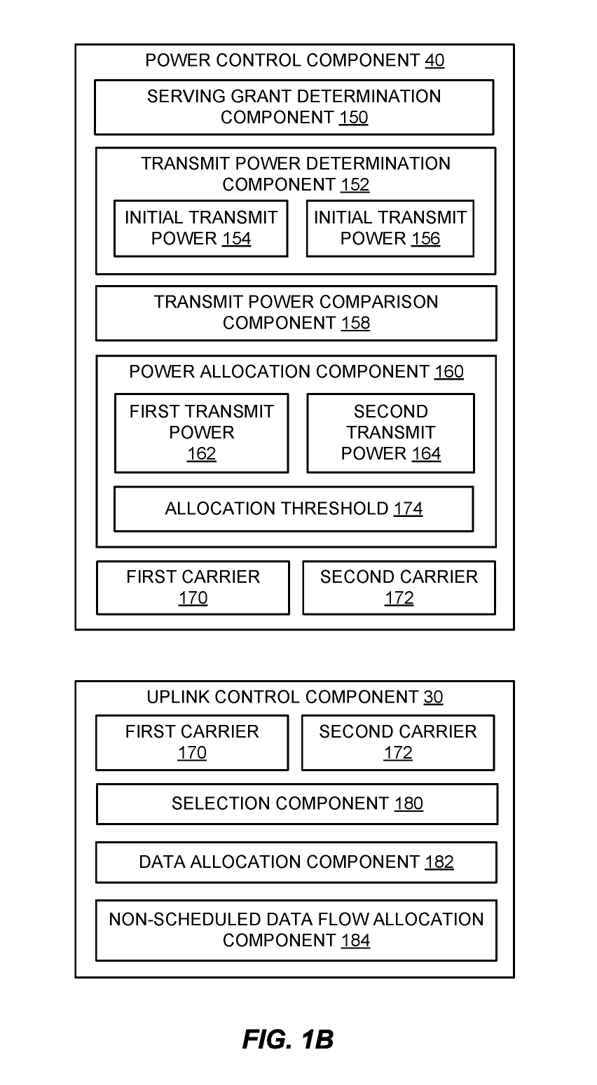

Referring to FIGS. 1A and 1B, in an aspect, a wireless communication system 10 includes at least one UE 12 in communication coverage of at least one network entity 14 (e.g., base station or node B, or a cell thereof, in an HSPA network). UE 12 may communicate with a network 18 via the network entity 14 and a radio network controller (RNC) 16. In some aspects, multiple UEs including UE 12 may be in communication coverage with one or more network entities, including network entity 14. Although various aspects are described in relation to a UMTS HSPA network, similar principles may be applied in an LTE network, Evolution-Data Optimized (EV-DO) network, or other wireless wide area networks (WWAN). The wireless network may employ a scheme where multiple base stations may transmit on a channel.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. UE 12 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, the UE 12 may include one or more processors 103 and a memory 130 that may operate in combination with an uplink control component 30 to control data allocation for multiple uplink channels. Correspondingly, as discussed below, in one or more aspects, network entity 14, such as a Node B, may include a power control component 40 that operates in conjunction with a processor 103 and memory 130 of network entity 14 to generate and send serving grants for the uplink channels.

For instance, power control component 40 may be configured to determine and allocate power to a carrier (e.g., DPCCH) having a lower pathloss relative to another carrier. Specifically, power control component 40 may include serving grant determination component 150, which may be configured to determine a first serving grant for the first carrier 170 and a second serving grant for the second carrier 172. Further, power control component 40 may include transmit power determination component 152, which may be configured to determine an initial transmit power 154 (e.g., an initial transmit power) for the first carrier 170 and an initial transmit power 156 (e.g., an initial transmit power) for the second carrier 172. Additionally, power control component 40 may include transmit power comparison component 158, which may be configured to determine whether a relative difference between the two initial transmit powers 154 and 156 exceeds a transmit power difference threshold, thereby indicating a sufficient carrier imbalance to trigger an allocation of power to a carrier exhibiting lower pathloss compared to another carrier (corresponding to a relative lower transmit power).

Power control component 40 may also be configured to determine whether the initial transmit power 154 of the first carrier 170 is less than the initial transmit power 156 of the second carrier 172. That is, to determine which channel or carrier is exhibiting lower pathloss, power control component 40, via transmit power comparison component 158, may be configured to determine which of the first carrier 170 or second carrier 172 has a lower transmit power (e.g., initial transmit power 154 or initial transmit power 156). Power control component 40 may further include power allocation component 160, which may be configured to allocate power to one or both of the first carrier 170 and/or the second carrier 172. For instance, based on a determination that the initial transmit power 154 of the first carrier 170 is less than the initial transmit power 156 of the second carrier 172, power allocation component 160 may allocate a first transmit power 162 to the first carrier 170. In some aspects, power allocation component 160 may determine a remaining transmit power following power allocation to the first carrier 170. In such instance, power allocation component 160 may allocate a second power 164 to the second carrier 172 corresponding to the remaining transmit power if the remaining transmit power meets or exceeds the allocation threshold 174, which may correspond to a minimum amount of power sufficient for power allocation (e.g., greater than ‘0’ dB).

For example, UE 12 may use uplink control component 30 to establish and control multiple uplink channels that connect UE 12 to the network entity 14. In an aspect, UE 12 can use uplink control component 30 to allocate, via data allocation component 182, data amongst the multiple uplink channels. For example, uplink control component 30 may be configured to receive a first power allocation for a first carrier 170 and a second power allocation for a second carrier 172. Further, for instance, uplink control component 30 may include selection component 180, which may be configured to select an E-TFC for each of the first carrier 170 and the second carrier 172 based on the first power allocation. Additionally, to allocate the data according to the received power allocation, uplink control component 30 may include data allocation component 182, which may be configured to allocate data to the first carrier 170 before the second carrier 172.

Moreover, in some aspects, to efficiently allocate a non-schedule data flow, uplink control component 30 may include non-schedule data flow allocation component 184, which may be configured to allocate a non-schedule data flow to the first carrier 170 before the second carrier 172. Further, uplink control component 30 may be configured to fill the first carrier 170 with non-scheduled data flows before allocating non-schedule data flows to the second carrier 172. In an aspect, the data may be allocated based on the relative transmission (e.g., transmit) powers of each uplink channel (e.g., first carrier 170 and second carrier 172). In an aspect, the data may be allocated based on the operating frequency of the uplink channel.

In an aspect, the term “component” as used herein may be one of the parts that make up a system, may be hardware, firmware, and/or software, and may be divided into other components. Uplink control component 30 may be communicatively coupled to a transceiver 106, which may include a receiver 32 for receiving and processing RF signals and a transmitter 34 for processing and transmitting RF signals. Processor 103 may be coupled to transceiver 106 and memory 130 via at least one bus 110.

Receiver 32 may include hardware, firmware, and/or software code executable by a processor for receiving data, the code comprising instructions and being stored in a memory (e.g., computer-readable medium). Receiver 32 may be, for example, a radio frequency (RF) receiver. In an aspect, the receiver 32 may receive signals transmitted by the network entity 14. The receiver 32 may obtain measurements of the signals. For example, the receiver 32 may determine Ec/Io, SNR, etc.

Transmitter 34 may include hardware, firmware, and/or software code executable by a processor for transmitting data, the code comprising instructions and being stored in a memory (e.g., computer-readable medium). The transmitter 34 may be, for example, a RF transmitter.

In an aspect, the one or more processors 103 can include a modem 108 that uses one or more modem processors. The various functions related to uplink control component 30 may be included in modem 108 and/or processors 103 and, in an aspect, can be executed by a single processor, while in other aspects, different ones of the functions may be executed by a combination of two or more different processors. For example, in an aspect, the one or more processors 103 may include any one or any combination of a modem processor, or a baseband processor, or a digital signal processor, or a transmit processor, or a transceiver processor associated with transceiver 106.

Moreover, in an aspect, UE 12 may include RF front end 104 and transceiver 106 for receiving and transmitting radio transmissions, for example, wireless communications 26 transmitted by the network entity 14. For example, transceiver 106 may communicate with modem 108 to transmit messages generated by uplink control component 30 and to receive messages and forward them to uplink control component 30.

RF front end 104 may be connected to one or more antennas 102 and can include one or more low-noise amplifiers (LNAs) 141, one or more switches 142, 143, one or more power amplifiers (PAs) 145, and one or more filters 144 for transmitting and receiving RF signals. In an aspect, components of RF front end 104 can connect with transceiver 106. Transceiver 106 may connect to one or more modems 108 and processor 103.

In an aspect, LNA 141 can amplify a received signal at a desired output level. In an aspect, each LNA 141 may have a specified minimum and maximum gain values. In an aspect, RF front end 104 may use one or more switches 142, 143 to select a particular LNA 141 and its specified gain value based on a desired gain value for a particular application.

Further, for example, one or more PA(s) 145 may be used by RF front end 104 to amplify a signal for an RF output at a desired output power level. In an aspect, each PA 145 may have a specified minimum and maximum gain values. In an aspect, RF front end 104 may use one or more switches 143, 146 to select a particular PA 145 and its specified gain value based on a desired gain value for a particular application.

Also, for example, one or more filters 144 can be used by RF front end 104 to filter a received signal to obtain an input RF signal. Similarly, in an aspect, for example, a respective filter 144 can be used to filter an output from a respective PA 145 to produce an output signal for transmission. In an aspect, each filter 144 can be connected to a specific LNA 141 and/or PA 145. In an aspect, RF front end 104 can use one or more switches 142, 143, 146 to select a transmit or receive path using a specified filter 144, LNA, 141, and/or PA 145, based on a configuration as specified by transceiver 106 and/or processor 103.

Transceiver 106 may be configured to transmit and receive wireless signals through antenna 102 via RF front end 104. In an aspect, transceiver may be tuned to operate at specified frequencies such that UE 12 can communicate with, for example, network entity 14 or network entity 20. In an aspect, for example, modem 108 can configure transceiver 106 to operate at a specified frequency and power level based on the UE configuration of the UE 12 and communication protocol used by modem 108.

In an aspect, modem 108 can be a multiband-multimode modem, which can process digital data and communicate with transceiver 106 such that the digital data is sent and received using transceiver 106. In an aspect, modem 108 can be multiband and be configured to support multiple frequency bands for a specific communications protocol. In an aspect, modem 108 can be multimode and be configured to support multiple operating networks and communications protocols. In an aspect, modem 108 can control one or more components of UE 12 (e.g., RF front end 104, transceiver 106) to enable transmission and/or reception of signals from the network based on a specified modem configuration. In an aspect, the modem configuration can be based on the mode of the modem and the frequency band in use. In another aspect, the modem configuration can be based on UE configuration information associated with UE 12 as provided by the network during cell selection and/or cell reselection.

UE 12 may further include memory 130, such as for storing data used herein and/or local versions of applications or uplink control component 30 and/or one or more of its subcomponents being executed by processor 103. Memory 130 can include any type of computer-readable medium usable by a computer or processor 103, such as random access memory (RAM), read only memory (ROM), tapes, magnetic discs, optical discs, volatile memory, non-volatile memory, and any combination thereof. In an aspect, for example, memory 130 may be a computer-readable storage medium that stores one or more computer-executable codes defining uplink control component 30 and/or one or more of its subcomponents, and/or data associated therewith, when UE 12 is operating processor 103 to execute uplink control component 30 and/or one or more of its subcomponents. In another aspect, for example, memory 130 may be a non-transitory computer-readable storage medium.

According to the present aspects, network entity 14 may include components similar to components included in UE 12, including for example, antenna 102, RF front end 104, transceiver 106, one or more processors 103, and memory 130. In an aspect, one or more processors 103 and memory 130 of network entity 14 may operate in combination with power control component 40 to control, via power allocation component 160, allocation of power for multiple uplink channels between network entity 14 and UE 12. For example, network entity 14 may, via transceiver 106, transmit and/or receive data using the antenna 102 on at least one of the first carrier 170 or the second carrier 172. Thus, as noted above, network entity 14 may also use power control component 40 to generate and send serving grants for the uplink channels.

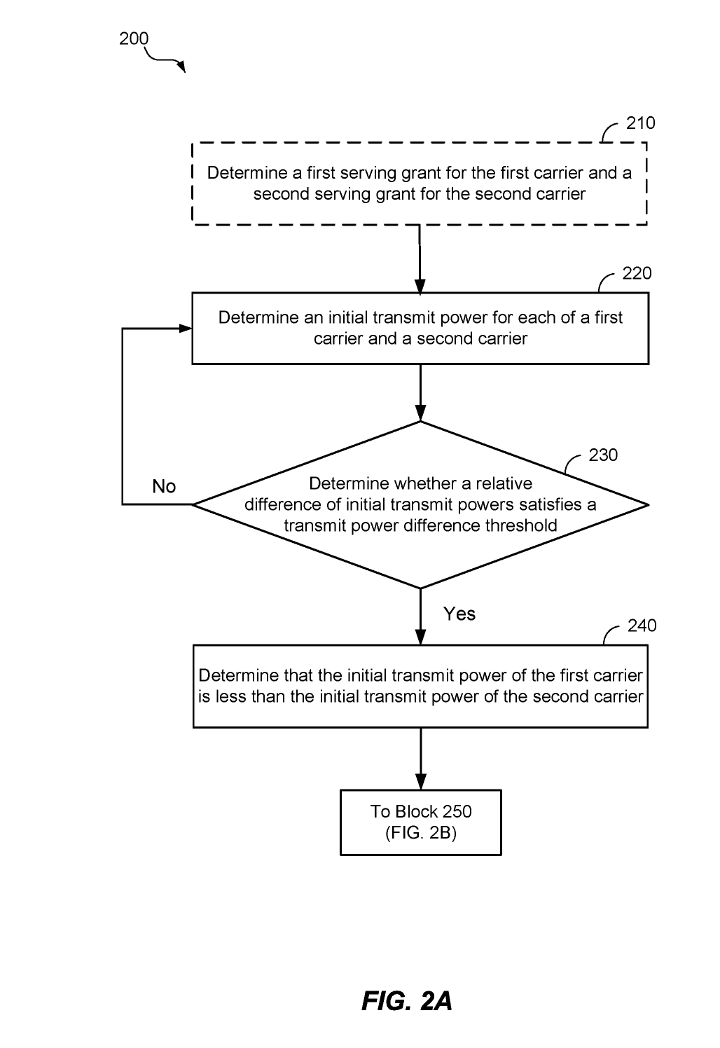

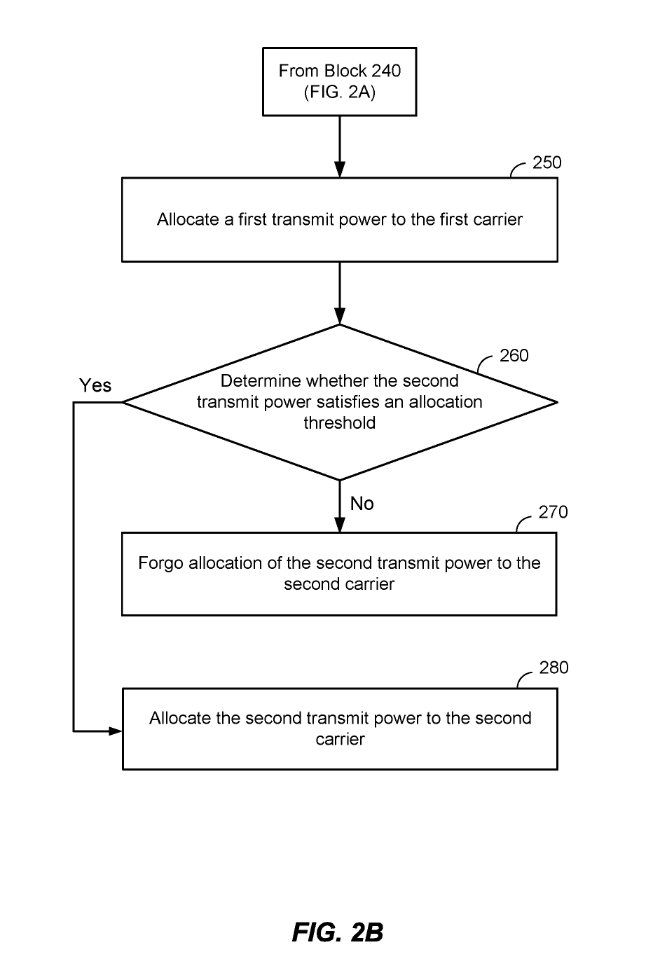

FIGS. 2A and 2B are flowcharts conceptually illustrating an example method of power allocation at a base station. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Network entity 14 may perform method 200, for example, when controlling power during the establishment and/or maintenance of multiple uplink channels used by UE 12.

In an aspect, at block 210, method 200 may optionally determine a first serving grant for the first carrier and a second serving grant for the second carrier. For example, in an aspect, power control component 40 may, via serving grant determination component 150, determine a first serving grant for the first carrier 170 and a second serving grant for the second carrier 172. In some aspects, a serving grant may specify a maximum power UE 12 can use on an enhanced dedicated physical data channel (E-DPDCH) in a current TTI. In some aspects, the first carrier 170 may be associated with a first DPCCH and a second carrier 172 may be associated with a second DPCCH adjacent to the first carrier in the frequency domain. That is, the second carrier 172 may be adjacent to the first carrier 170 in the frequency domain.

At block 220, method 200 may determine an initial transmit power for each of a first carrier and a second carrier. In an aspect, for example, power control component 40 may, via transmit power determination component 152, determine an initial transmit power 154 for the first carrier 170 (e.g., corresponding to a first DPCCH) and an initial transmit power 156 for the second carrier 172 (e.g., corresponding to a second DPCCH) for a connected dual-band dual-channel UE using HSUPA. In some aspects, the initial transmit powers 154 and 156 for each of the first carrier 170 and second carrier 172 may be initially allocated from a total available transmit power. Further, in some aspects, the total available transmit power may be an amount of power initially available for allocation at the UE 12, and may also correspond to a maximum power available for allocation on each channel or carrier at UE 12.

Further, at block 230, method 200 may determine whether a relative difference of initial transmit powers satisfies a transmit power difference threshold. For example, in an aspect, power control component 40 may, via transmit power determination component 152, determine whether an relative difference between an initial transmit power 154 of the first carrier 170 and an initial transmit power 156 of the second carrier 172 satisfies (e.g., meets or exceeds) a transmit power difference threshold. That is, transmit power determination component 152 may initially determine a difference in power level between the initial transmit power 154 of first carrier 170 and the initial transmit power 156 of second carrier 172. Transmit power determination component 152 may then determine whether the difference in power level is sufficiently large enough such that it represents a carrier imbalance. In some aspects, the transmit power difference threshold represents a minimum transmit power difference level that triggers or permits a power allocation to a carrier exhibiting lower pathloss (e.g., lower transmit power) compared to another carrier. Further, for example, as part of the determination at block 230, method 200 may also determine the relative difference of initial transmit powers between the initial transmit power 154 of the first carrier 170 and the initial transmit power 156 of the second carrier 172.

Method 200 may proceed to block 220 based on a determination that the relative difference of transmit powers does not exceed the transmit power difference threshold. Alternatively, although not shown, method 200 may allocate power to the second carrier irrespective of the determination at block 240. That is, method 200 may allocate a first transmit power to a second carrier prior to allocating the first transmit power to the first carrier.

Method 200 may proceed to block 240 based on a determination that the relative difference of initial transmit powers exceeds the transmit power difference threshold. Specifically, at block 240, in an aspect, method 200 may determine that the initial transmit power of the first carrier is less than the initial transmit power of the second carrier. For example, in an aspect, power control component 40 may, via transmit power comparison component 158, determine that the initial transmit power 154 of the first carrier 170 is less than the initial transmit power 156 of the second carrier 172 such that the first carrier exhibits lower pathloss. In some aspects, a pathloss associated with the first carrier 170 and a pathloss associated with the second carrier 172 are proportional to the initial transmit power 154 of the first carrier 170 and the initial transmit power 156 of the second carrier 172.

At block 250, in an aspect, method 200 may allocate a first transmit power to the first carrier. For example, in an aspect, power control component 40 may, via power allocation component 160, allocate first transmit power 162 from a total transmit power to the first carrier 170 based on determining that the initial transmit power 154 of the first carrier 170 is less than the initial transmit power 156 of the second carrier 172. In some aspects, power control component 40 may, via power allocation component 160, prioritize the power allocation to the first carrier 170 when the initial transmit power 154 of the first carrier 170 is less than the initial transmit power 156 of the second carrier 172.

In some aspects, allocating the first transmit power 162 to the first carrier 170 may be based on the first serving grant such that the first transmit power 162 does not meet and/or exceed (e.g., violate) the first serving grant. Accordingly, in some aspects, a sum of the initial transmit power 154 of the first carrier 170 and the first transmit power 162 may be less than or equal to the first serving grant. In some aspects, at block 250, method 200 may allocate first power 162 to the first carrier 170 from the total available transmit power minus or subtracting the initial transmit power 154 of the first carrier 170 and the initial transmit power 156 of the second carrier 172. As such, the total transmit power of the first carrier 170 is equal to the initial transmit power 154 of the first carrier 170 plus or in addition to the allocated first transmit power 162. In some aspects, the first transmit power 162 may be allocated to the first carrier 170 without exceeding or violating the first serving grant.

At block 260, method 200 may determine whether the second transmit power satisfies an allocation threshold. For instance, in an aspect, power control component 40 may, via power allocation component 160, determine whether the second transmit power 164 satisfies an allocation threshold 174 (e.g., a value greater than zero). In other words, power allocation component 160 may, after allocating first transmit power 162 to first carrier 170, determine whether any power from the total available transmit power remains for allocation to the second carrier 172. In some aspects, a transmit power that remains following allocation to the first transmit power 162 may be referred to as the remaining transmit power, which may, in some aspects, correspond in value to the second transmit power 164. If the second transmit power 164 satisfies the allocation threshold, which may be a power value indicative of a minimum amount sufficient for allocation to the second carrier 172, then method 200 may proceed to block 280, otherwise method 200 may proceed to block 270.

Method 200 may proceed to block 270 based on a determination that the second transmit power does not satisfy the allocation threshold. Specifically, at block 270, method 200 may forgo allocation of the second transmit power to the second carrier. For example, in an aspect, power control component 40 may, via power allocation component 160, forgo allocation of the second transmit power 164 to the second carrier 172 based on determining that the second transmit power 164 does not satisfy the allocation threshold 174 (e.g., not greater than zero dB). Nonetheless, method 200 may proceed to block 280 based on a determination that the second transmit power satisfies the allocation threshold.

In particular, at block 280, method 200 may allocate a second transmit power to the second carrier. In an aspect, for example, the power control component 40 may, via power allocation component 160, allocate the second power 164 to the second carrier 172 based on or corresponding to a difference between the total transmit power and the first power 162 (e.g., power allocated to the first carrier 170). In some aspects, the second transmit power 164 may be based on a difference between a total transmit power of the UE 12, the initial transmit powers 154 and 156 for each of the first and second carriers 170 and 172, and the first transmit power 162 of the first carrier 170.

In an aspect, for example, the total power available to the UE 12 may be less than the total granted power of the uplink channels. In some aspects, allocating the second transmit power 164 to the second carrier 172 may be based on the second serving grant such that the second transmit power 164 does not meet and/or exceed (e.g., violate) the second serving grant. In some aspects, at block 280, method 200 may allocate second transmit power 164 to the second carrier 172 from the total available transmit power less the first transmit power 162 and the initial transmit power 156 of the second carrier 172. As such, the total transmit power of the second carrier 172 is equal to the transmit power 156 of the second carrier 172 plus or in addition to the allocated second transmit power 164.

Further, in some aspects, although not shown, method 200 may select an E-TFC for each of the first carrier 170 and the second carrier 172 based on determining that the initial transmit power 154 of the first carrier 170 is less than the initial transmit power 156 of the second carrier 172. Accordingly, method 200 may allocate data to the first carrier 170 prior to allocating data to the second carrier 172. In some aspects, selecting the E-TFC for each of the first carrier 170 and the second carrier 172 includes selecting the E-TFC for the first carrier 170 based on a first serving grant associated with the first carrier 170 and the E-TFC for the second carrier 172 based on a second serving grant associated with the second carrier 172.

Additionally, in some aspects, although not shown, method 200 may allocate a non-scheduled data flow to the first carrier 170 prior to the second carrier 172 based on determining that the initial transmit power 154 of the first carrier 170 is less than the initial transmit power 156 of the second carrier 172. In some aspects, the first carrier 170 may be lower in frequency than the second carrier 172.

In a non-limiting use case, for example, UE 12 may have a maximum transmit power of 23 dBm, while each uplink channel or carrier may use up to 23 dB as their respective transmit powers. In an aspect, a first uplink channel or carrier operating at 900 MHz may have a relative 10 dB better path loss than a second uplink channel or carrier operating a 2 GHz. UE 12 may have 22.7 dBm as remaining transmit power for scheduled transmissions. In an aspect, if the Node B allocated power equally, each uplink channel with have 30 dB allocated and, due to the 10 dB difference, the first uplink channel would have 12.3 dBm allocated, while the second uplink channel would have 22.3 dBm allocated. As a result, the total transport block size scheduled would be 1756 bits. In contrast, if power control component 40 allocated power by prioritizing the uplink channel with the lower transmit power (e.g., the first uplink channel), that channel would be allocate the majority of the remaining transmit power. This may result in an allocated transport block size of 9939 bits, which may allow a more efficient transmission of data.

In a similar example, an equal distribution of power by power control component 40 between a first and second uplink channels or carriers when the remaining transmit power is 21.9 dBm may result in allocations of 11.5 dBm and 21.5 dBm, respectively, of the first and second uplink channels. This may result in a scheduled transport block size of 460 bits. In contrast, when power control component 40 prioritizes the uplink channel with the power transmit power, power control component 40 may allocate all of the remaining transmit power to the first uplink channel. This may result in a scheduled transport block size of 2798 bits.

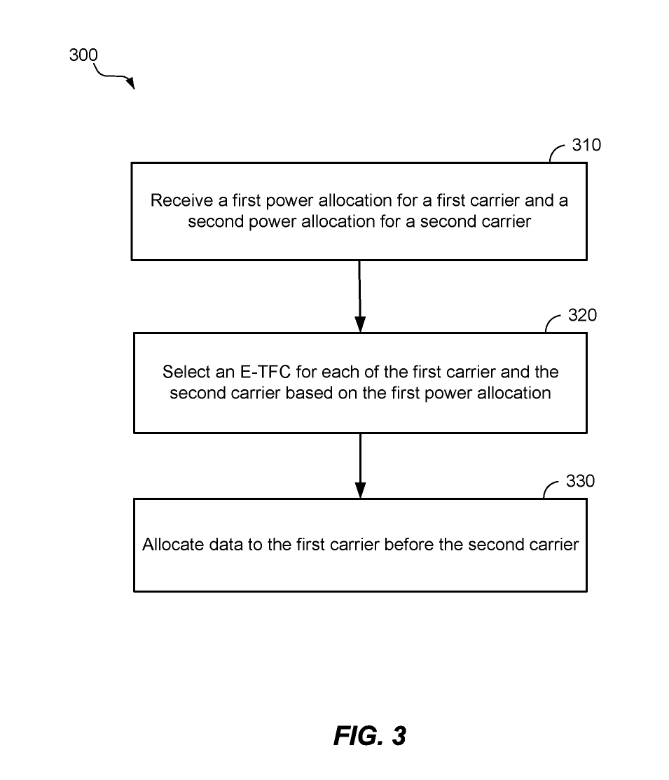

FIG. 3 is a flowchart conceptually illustrating an example method of allocating data to uplink channels for wireless communications. UE 12 may use uplink control component 30 to perform method 300, for example, upon receiving the serving grant and respective power allocations from network entity 14.

At block 310, method 300 may receive a first power allocation for a first carrier and a second power allocation for a second carrier. For example, UE 12 may receive a first power allocation for a first carrier and a second power allocation for a second carrier. In an aspect, the first power allocation may be higher than the second power allocation. In an aspect, the transmit power of the first carrier may be lower than a second transmit power of the second carrier.

At block 320, in an aspect, method 300 may select a E-TFC for each of the first and second carriers based on the first power allocation. For example, in an aspect, uplink control component 30 may select an E-TFC for each of the first carrier and the second carrier based on the first power allocation. In an aspect, the uplink control component 30 may select from a list of available values for the E-TFC such that the selection of the E-TFC for an uplink channel may be based at least on the values of the serving grant and/or the power allocation as provided by network entity 14.

At block 330, in an aspect, method 300 may allocate data to the first carrier before the second carrier. In an aspect, for example, the uplink control component 30 may fill the first carrier before allocating data to the second carrier. Sending data over the uplink channel with the lower transmit power and/or higher power allocation may, for example, improve the link efficiency of with network entity 14.

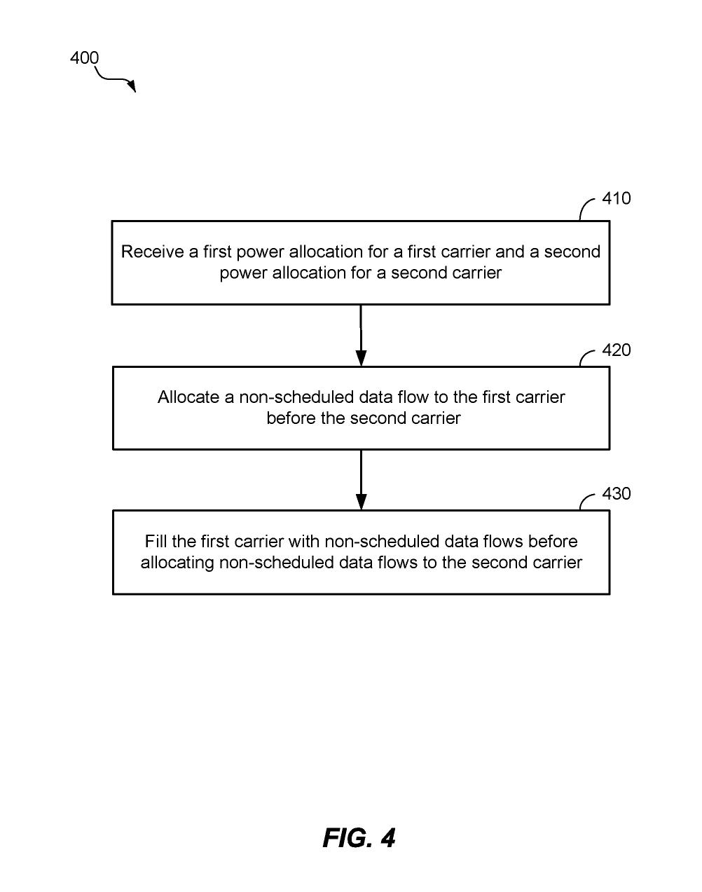

FIG. 4 is a flowchart conceptually illustrating another example method of allocating data to uplink channels for wireless communications. UE 12 may use uplink control component 30 to perform method 400, for example, upon receiving the serving grant and respective power allocations from Network entity 14 and upon receiving un-scheduled data that is to be uploaded to the network.

At block 410, in an aspect, method 400 may receive a first power allocation for a first carrier and a second power allocation for a second carrier. For example, uplink control component of UE 12 may receive a first power allocation for a first carrier and a second power allocation for a second carrier. In an aspect, the first power allocation may be higher than the second power allocation and a transmit power of the first carrier may be lower than a second transmit power of the second carrier.

At block 420, in an aspect, method 400 may allocate a non-scheduled data flow to the first carrier. In an aspect, uplink control component 30 may allocate the non-scheduled data flow to the first carrier before the second carrier. In an aspect, uplink control component 30 may prioritize allocating the non-scheduled data flow to the uplink channel operating at the lower relative frequency. In some instances, the uplink channel operating at the lower frequency may also operate using lower transmit power. In an aspect, the non-scheduled data flow may include a signaling radio bearer (SRB).

At block 430, in an aspect, method 400 may optionally fill the first carrier with non-scheduled data flows before allocating data to the second carrier. For example, in an aspect, uplink control component 30 may prioritize the first uplink channel such that the first carrier is filled with non-scheduled data flows first before uplink control component 30 begins allocating data (including non-scheduled data flows) to the second carrier.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of power allocation at a network entity, comprising:
determining, by a power control component of the network, an initial transmit power for each of a first carrier and a second carrier for a user equipment (UE);
determining, by the power control component, that the initial transmit power of the first carrier is less than the initial transmit power of the second carrier;
allocating a first transmit power to the first carrier prior to allocating a second transmit power to the second carrier based on determining that the initial transmit power of the first carrier is less than the initial transmit power of the second carrier, wherein the first transmit power is greater than the second transmit power.

2. The method of claim 1, further comprising determining a first serving grant for the first carrier and a second serving grant for the second carrier,
wherein allocating the first transmit power to the first carrier is further based on the first serving grant, and
wherein allocating the second transmit power to the second carrier is further based on the second serving grant.

3. The method of claim 2, wherein the first transmit power is allocated to the first carrier without exceeding the first serving grant.

4. The method of claim 2, wherein a sum of the initial transmit power of the first carrier and the first transmit power is less than or equal to the first serving grant.

5. The method of claim 1, wherein the second transmit power is based on a difference between a total transmit power of the UE, the initial transmit power for each of the first and second carriers, and the first transmit power of the first carrier.

6. The method of claim 1, further comprising:
determining whether the second transmit power satisfies an allocation threshold, wherein allocating the second transmit power to the second carrier includes:
allocating the second transmit power based on determining that the second transmit power satisfies the allocation threshold; and
forgoing allocation of the second transmit power to the second carrier based on determining that the second transmit power does not satisfy the allocation threshold.

7. The method of claim 1, further comprising:
determining a relative difference of initial transmit powers between the initial transmit power of the first carrier and the initial transmit power of the second carrier; and
determining whether the relative difference of initial transmit powers satisfies a transmit power difference threshold,
wherein allocating the first transmit power to the first carrier includes allocating the first transmit power based on determining that the relative difference of initial transmit powers satisfies the transmit power difference threshold.

8. The method of claim 1, wherein a pathloss associated with the first carrier and a pathloss associated with the second carrier are proportional to the initial transmit power of the first carrier and the initial transmit power of the second carrier.

9. The method of claim 1, wherein the second carrier is adjacent to the first carrier in a frequency domain.

10. The method of claim 1, further comprising:
selecting an enhanced dedicated channel (E-DCH) transport format combination (E-TFC) for each of the first carrier and the second carrier based on determining that the initial transmit power of the first carrier is less than the initial transmit power of the second carrier; and
allocating data to the first carrier prior to allocating data to the second carrier.

11. The method of claim 10, wherein selecting the E-TFC for each of the first carrier and the second carrier includes selecting the E-TFC for the first carrier based on a first serving grant associated with the first carrier and the E-TFC for the second carrier based on a second serving grant associated with the second carrier.

12. The method of claim 1, further comprising allocating a non-scheduled data flow to the first carrier prior to the second carrier based on determining that the initial transmit power of the first carrier is less than the initial transmit power of the second carrier.

13. The method of claim 12, wherein the first carrier is lower in frequency than the second carrier.

14. The method of claim 1, wherein the UE is a dual-band dual-carrier (DB-DC) UE.

15. An apparatus for power allocation, comprising:
a memory configured to store data; and
at least one processor communicatively coupled to the memory, wherein the at least one processor is configured to:
determine an initial transmit power for each of a first carrier and a second carrier for a UE;
determine that the initial transmit power of the first carrier is less than the initial transmit power of the second carrier;
allocate a first transmit power to the first carrier prior to allocating a second transmit power to the second carrier based on determining that the initial transmit power of the first carrier is less than the initial transmit power of the second carrier, wherein the first transmit power is greater than the second transmit power.

16. The apparatus of claim 15, wherein the at least one processor is further configured to determine a first serving grant for the first carrier and a second serving grant for the second carrier,
wherein allocating the first transmit power to the first carrier is further based on the first serving grant, and
wherein allocating the second transmit power to the second carrier is further based on the second serving grant.

17. The apparatus of claim 16, wherein the first transmit power is allocated to the first carrier without exceeding the first serving grant.

18. The apparatus of claim 16, wherein a sum of the initial transmit power of the carriers and the first transmit power is less than or equal to the first serving grant.

19. The apparatus of claim 15, wherein the second transmit power is based on a difference between the total transmit power of the UE, the initial transmit power for each of the first and second carriers, and the first transmit power of the first carrier.

20. The apparatus of claim 15, wherein the at least one processor is further configured to:
determine whether the second transmit power satisfies an allocation threshold, wherein to allocate the second transmit power to the second carrier, the at least one processor is further configured to:
allocate the second transmit power based on determining that the second transmit power satisfies the allocation threshold; and
forgo allocation of the second transmit power to the second carrier based on determining that the second transmit power does not satisfy the allocation threshold.

21. The apparatus of claim 15, wherein the at least one processor is further configured to determine a relative difference of initial transmit powers between the initial transmit power of the first carrier and the initial transmit power of the second carrier; and
determine whether the relative difference of initial transmit powers satisfies a transmit power difference threshold,
wherein to allocate the first transmit power to the first carrier, the at least one processor is further configured to allocate the first transmit power based on determining that the relative difference of initial transmit powers satisfies the transmit power difference threshold.

22. The apparatus of claim 15, wherein a pathloss associated with the first carrier and a pathloss associated with the second carrier are proportional to the initial transmit power of the first carrier and the initial transmit power of the second carrier.

23. The apparatus of claim 15, wherein the second carrier is adjacent to the first carrier in a frequency domain.

24. The apparatus of claim 15, wherein the at least one processor is further configured to:
select an enhanced dedicated channel (E-DCH) transport format combination (E-TFC) for each of the first carrier and the second carrier based on determining that the initial transmit power of the first carrier is less than the initial transmit power of the second carrier; and
allocate data to the first carrier prior to allocating data to the second carrier.

25. The apparatus of claim 24, wherein to select the E-TFC for each of the first carrier and the second carrier, the at least one processor is further configured to select the E-TFC for the first carrier based on a first serving grant associated with the first carrier and the E-TFC for the second carrier based on a second serving grant associated with the second carrier.

26. The apparatus of claim 15, wherein the at least one processor is further configured to allocate a non-scheduled data flow to the first carrier prior to the second carrier based on determining that the initial transmit power of the first carrier is less than the initial transmit power of the second carrier.

27. The apparatus of claim 26, wherein the first carrier is lower in frequency than the second carrier.

28. The apparatus of claim 15, further comprising one or more antennas configured to transmit data on at least one of the first carrier or the second carrier, wherein the UE is a dual-band dual-carrier (DB-DC) UE.

29. A computer-readable medium storing computer executable code for power allocation, comprising code for:
determining an initial transmit power for each of a first carrier and a second carrier for a UE;
determining that the initial transmit power of the first carrier is less than the initial transmit power of the second carrier;
allocating a first transmit power to the first carrier prior to allocating a second transmit power to the second carrier based on determining that the initial transmit power of the first carrier is less than the initial transmit power of the second carrier, wherein the first transmit power is greater than the second transmit power.

30. An apparatus for power allocation, comprising:
means for determining an initial transmit power for each of a first carrier and a second carrier for a UE;
means for determining that the initial transmit power of the first carrier is less than the initial transmit power of the second carrier;
means for allocating a first transmit power to the first carrier prior to allocating a second transmit power to the second carrier based on determining that the initial transmit power of the first carrier is less than the initial transmit power of the second carrier, wherein the first transmit power is greater than the second transmit power.
